(19) United States
(12) Patent Application Publication
(10) Pub. No.: US 2008/0272650 A1
(43) Pub. Date: Nov. 6, 2008

(54) XDSL CPE and power system thereof

(76) Inventor: Chuan-Hsing Chen, Jhonghe City (TW)

Correspondence Address: WEI TE CHUNG;FOXCONN INTERNATIONAL, INC., 1650 MEMOREX DRIVE, SANTA CLARA, CA, 95050, US

(21) Appl. No.: 11/657,514

(22) Filed: Jan. 23, 2007

(30) Foreign Application Priority Data
Jan. 25, 2006 (TW) 95102761

(51) Int. Cl. H02J 1/00; H02M 3/156

(52) U.S. Cl. 307/31

(57) ABSTRACT

A power system includes a power adapter, a first power sub-system, and a second power sub-system. The power adapter provides a first DC power. The first power sub-system includes a first converter and a first controlling circuit. The first converter converts a first DC voltage into a second DC voltage, and the first controlling circuit controls a boot time of the first converter. The second power sub-system includes a second converter and a second controlling circuit. The second converter converts the first DC voltage into a third DC voltage, and the second controlling circuit controls the boot time of the second converter.

### BACKGROUND OF THE INVENTION

1. Field of the Invention

The invention generally relates to a customer premise equipment (CPE) and a power system thereof, and particularly to a digital subscriber loop (XDSL) CPE and a power system thereof.

2. Description of Related Art

Power controlling systems are used for controlling boot sequences of power systems of XDSL customer premise equipments (CPE). FIG. 1 is a block diagram of a conventional power system. A power adapter 102 converts an alternating current (AC) voltage into a first direct current (DC) voltage. A first converter 104 converts the first DC voltage into a second DC voltage, and supplies the second DC voltage to a central processing unit (CPU) 110. A second converter 106 converts the second DC voltage into a third DC voltage, and supplies the third DC voltage to the CPU 110. A boot controller 108 controls a time for supplying the second DC voltage and the third DC voltage to the CPU 110. However, the boot controller 108 increases overall cost and power consumption of the power system, and needs extra printed circuit board (PCB) space.

Therefore, a heretofore unaddressed need exists in the industry to overcome the aforementioned deficiencies and inadequacies.

### SUMMARY OF THE INVENTION

A power system is provided. The power system includes a power adapter, a first power sub-system, and a second power sub-system. The power adapter provides a first DC voltage. The first power sub-system includes a first converter and a first controlling circuit. The first converter converts a first DC voltage into a second DC voltage, and the first controlling circuit controls a boot/activation time of the first converter. The second power sub-system includes a second converter and a second controlling circuit. The second converter converts the first DC voltage into a third DC voltage, and the second controlling circuit controls the boot/activation time of the second converter.

An XDSL CPE including a power system is also provided. The power system includes a power adapter, a first power sub-system, and a second power sub-system. The power adapter provides a first DC power. The first power sub-system includes a first converter and a first controlling circuit. The first converter converts a first DC voltage into a second DC voltage, and the first controlling circuit controls a boot time of the first converter. The second power sub-system includes a second converter and a second controlling circuit. The second converter converts the first DC voltage into a third DC voltage, and the second controlling circuit controls the boot time of the second converter.

Other advantages and novel features will become more apparent from the following detailed description when taken in conjunction with the accompanying drawings, in which:

### BRIEF DESCRIPTION OF THE DRAWINGS

FIG. 1 is a block diagram of a conventional power system;

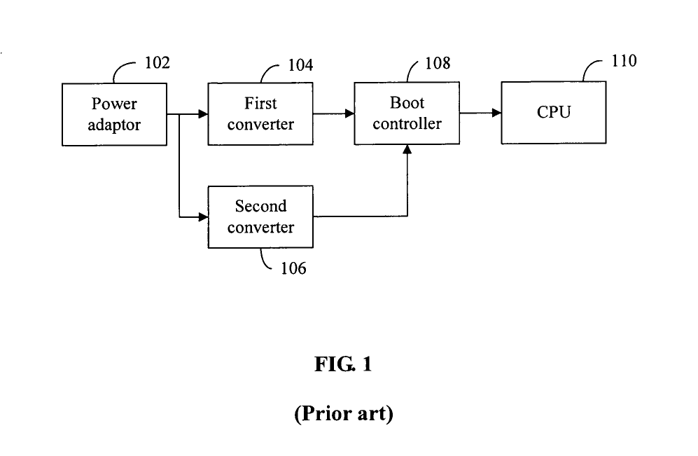

FIG. 2 is a block diagram of a power system in accordance with an embodiment of the invention;

FIG. 3 is a circuit diagram of a first power sub-system in accordance with an embodiment of the invention; and

FIG. 4 is a circuit diagram of a second power sub-system in accordance with an embodiment of the invention.

### DETAILED DESCRIPTION OF THE INVENTION

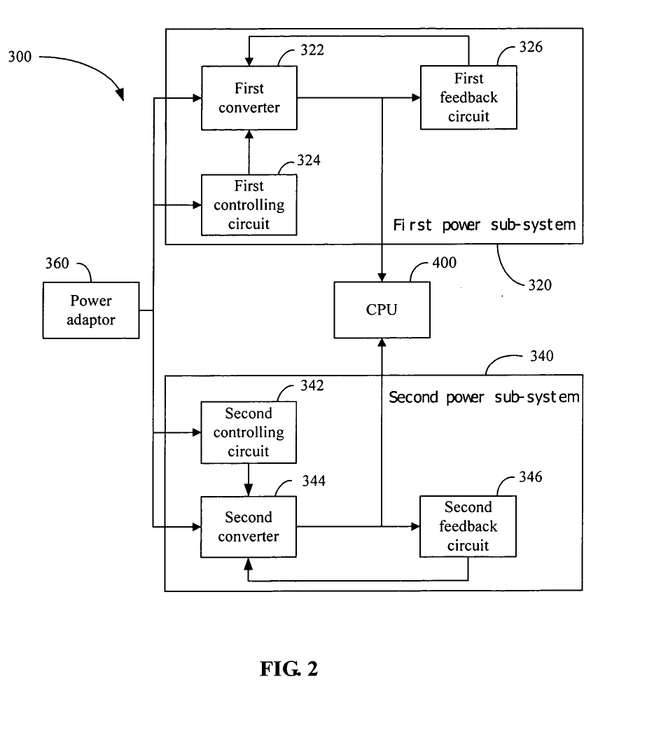

Referring to FIG. 2, a block diagram of a power system 300 of an embodiment of the invention is shown.

The power system 300 includes a first power sub-system 320, a second power sub-system 340, and a power adapter 360.

The power adapter 360 supplies a first DC voltage to the first power sub-system 320 and the second power sub-system 340.

The first power sub-system 320 is connected to the power adapter 360 and a CPU 400. The first power sub-system 320 includes a first converter 322, a first controlling circuit 324, and a first feedback circuit 326.

The first converter 322 is connected to the power adapter 360 and the CPU 400, for converting the first DC voltage supplied from the power adapter 360 into a second DC voltage, and supplying the second DC voltage to the CPU 400.

The first controlling circuit 324 is connected to the power adapter 360 and the first converter 322, for controlling a boot/activation time of the first converter 322.

The first feedback circuit 326 is connected to the first converter 322, for feeding back a fourth DC voltage thereto.

The second power sub-system 340 is connected to the power adapter 360 and the CPU 400. The second power sub-system 340 includes a second converter 342, a second controlling circuit 344, and a second feedback circuit 346.

The second converter 342 is connected to the power adapter 360 and the CPU 400, for converting the first DC voltage supplied from the power adapter 360 into a third DC voltage, and supplying the third DC voltage to the CPU 400.

The second controlling circuit 344 is connected to the power adapter 360 and the second converter 342, for controlling a boot/activation time of the second converter 342.

The second feedback circuit 326 is connected to the second converter 342, for feeding back a fifth DC voltage thereto.

In this embodiment, the power system 300 sequentially converts the first DC voltage supplied from the power adapter 360 into the second DC voltage and the third DC voltage. The second DC voltage is higher than the third DC voltage, and the boot time of the first converter 322 is different from that of the second converter 342.

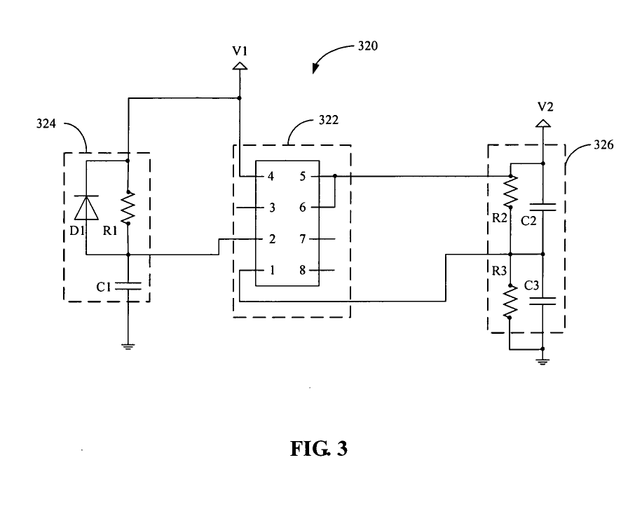

FIG. 3 is a circuit diagram of the first power sub-system 320.

In this embodiment, the first power sub-system 320 converts the first DC voltage V1 into the second DC voltage V2, and supplies the second DC voltage V2 to the CPU 400 (not shown).

The first converter 322 includes a plurality of pins, in which pin 1 is a feedback pin, pin 2 is an enable pin, pin 4 is an input, and pin 5 and pin 6 are outputs.

The first controlling circuit 324 includes a resistor R1, a capacitor C1, and a diode D1. One end of the resistor R1 is connected to the power adapter 360 (FIG. 2), and the other end thereof is connected to pin 2. One end of the resistor C1 is connected to pin 2, and the other end thereof is connected to ground. One end of the diode D1 is connected to the power adapter 360 (FIG. 2), and the other end thereof is connected to pin 2.

The first feedback circuit 326 includes two resistors R2 and R3, and two capacitors C2 and C3. The two resistors R2 and R3 form a voltage dividing circuit. One end of the resistor R2 is connected to pin 5 and pin 6, and the other end thereof is connected to pin 1. One end of the resistor R3 is connected to pin 1, and the other end thereof is connected to ground. One end of the capacitor C2 is connected to pin 5 and pin 6, and the other end thereof is connected to pin 1. One end of the capacitor C3 is connected to pin 1, and the other end thereof is connected to ground.

In this embodiment, the resistor R1, the capacitor C1, and the diode D1 form a delay circuit, for controlling the boot time of the first converter 322 through pin 2, thereby further controlling a time for supplying the second DC voltage V2 to the CPU 400 by the first converter 322.

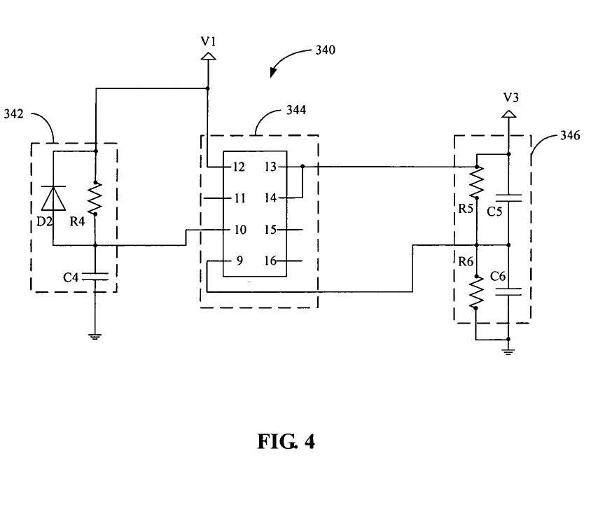

FIG. 4 is a circuit diagram of the second power sub-system 340 of an embodiment of the invention.

In this embodiment, the second power sub-system 340 converts the first DC voltage V1 into the third DC voltage V3, and supplies the third DC voltage V3 to the CPU 400 (not shown).

The second converter 342 includes a plurality of pins, in which pin 9 is a feedback pin, pin 10 is an enable pin, pin 12 is an input, pin 13 and pin 14 are outputs.

The second controlling circuit 344 includes a resistor R4, a capacitor C4, and a diode D2. One end of the resistor R4 is connected to the power adapter 360 (FIG. 2), and the other end thereof is connected to pin 10. One end of the resistor C4 is connected to pin 10, and the other end thereof is connected to ground. One end of the diode D2 is connected to the power adapter 360 FIG. 2), and the other end thereof is connected to pin 10.

The second feedback circuit 346 includes two resistors R5 and R6, and two capacitors C5 and C6. The two resistors R5 and R6 form a voltage dividing circuit. One end of the resistor R5 is connected to pin 13 and pin 14, and the other end thereof is connected to pin 9. One end of the resistor R6 is connected to pin 9, and the other end thereof is connected to ground. One end of the capacitor C5 is connected to pin 13 and pin 14, and the other end thereof is connected to pin 9. One end of the capacitor C6 is connected to pin 9, and the other end thereof is connected to ground.

In this embodiment, the resistor R4, the capacitor C4, and the diode D2 form a delay circuit, for controlling the boot time of the second converter 342 through pin 10, thereby controlling a time of supplying the third DC voltage V3 to the CPU 400 by the second converter 342.

In this embodiment, since a resistance value of the resistor R4 is larger than that of the resistor R1, and a capacitance value of the capacitor C4 is larger than that of the capacitor C1, a delay time of the delay circuit formed by R4, C4, and D2 is longer than that of the delay circuit formed by R1, C1, and D1, such that a process of supplying voltage to the CPU by the second power sub-system 340 lags behind that of the first power sub-system 320.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments.

What is claimed is:

1. A power system, comprising:
a power adapter for supplying a first direct current (DC) voltage;
a first power sub-system, comprising:
a first converter for converting the first DC voltage into a second DC voltage; and
a first controlling circuit for controlling a boot time of the first converter; and
a second power sub-system, comprising:
a second converter for converting the first DC voltage into a third DC voltage; and
a second controlling circuit for controlling a boot time of the second converter.

2. The power system in accordance with claim 1, wherein the first power sub-system further comprises:
a first feedback circuit connected to the first converter, for feeding back a fourth DC voltage thereto; and
a second feedback circuit connected to the second converter, for feeding back a fifth DC voltage thereto.

3. The power system in accordance with claim 1, wherein the second DC voltage is higher than the third DC voltage.

4. The power system in accordance with claim 1, wherein the first controlling circuit comprises a first resistor, having one end connected to the power adapter, and the other end connected to the first converter.

5. The power system in accordance with claim 4, wherein the first controlling circuit further comprises a first capacitor, having one end connected to the power adapter, and the other end connected to ground.

6. The power system in accordance with claim 5, wherein the first controlling circuit further comprises a first diode, having one end connected to the first converter, and the other end connected to the power adapter.

7. The power system in accordance with claim 1, wherein the first controlling circuit comprises a second resistor, having one end connected to the power adapter, and the other end connected to the second converter.

8. The power system in accordance with claim 7, wherein the second controlling circuit further comprises a second capacitor, having one end connected to the power adapter, and the other end connected to ground.

9. The power system in accordance with claim 8, wherein the second controlling circuit further comprises a second diode, having one end connected to the second converter, and the other end connected to the power adapter.

10. A digital subscriber loop customer premise equipment (XDSL CPE) comprising a power system, the power system comprising:
a power adapter for supplying a first direct current (DC) voltage;
a first power sub-system, comprising:
a first converter for converting the first DC voltage into a second DC voltage; and
a first controlling circuit for controlling a boot time of the first converter; and
a second power sub-system, comprising:
a second converter for converting the first DC voltage into a third DC voltage; and
a second controlling circuit for controlling a boot time of the second converter.

11. The XDSL CPE in accordance with claim 1 0, wherein the first power sub-system further comprises:
a first feedback circuit connected to the first converter, for feeding back a fourth DC voltage thereto;
a second feedback circuit connected to the second converter, for feeding back a fifth DC voltage thereto.

12. The XDSL CPE in accordance with claim 10, wherein the second DC voltage is higher than the third DC voltage.

13. The XDSL CPE in accordance with claim 10, wherein the first controlling circuit comprises a first resistor, having one end connected to the power adapter, and the other end connected to the first converter.

14. The XDSL CPE in accordance with claim 13, wherein the first controlling circuit further comprises a first capacitor, having one end connected to the power adapter, and the other end connected to ground.

15. The XDSL CPE in accordance with claim 14, wherein the first controlling circuit further comprises a first diode, having one end connected to the first converter, and the other end connected to the power adapter.

16. The XDSL CPE in accordance with claim 10, wherein the first controlling circuit comprises a second resistor, having one end connected to the power adapter, and the other end connected to the second converter.

17. The XDSL CPE in accordance with claim 16, wherein the second controlling circuit further comprises a second capacitor, having one end connected to the power adapter, and the other end connected to ground.

18. The XDSL CPE in accordance with claim 17, wherein the second controlling circuit further comprises a second diode, having one end connected to the second converter, and the other end connected to the power adapter.

19. An electronic equipment comprising:
a power adapter for supplying a first voltage power;
a converter electrically connectable with said power adapter to accept said first voltage power therefrom and convert said first voltage power into a second voltage power for output; and
a controlling circuit electrically connectable between said power adapter and said converter for accepting said first voltage power to delay activation time of said converter for outputting said second voltage power out of said converter.

20. The equipment in accordance with claim 19, further comprising another converter electrically connectable with said power adapter and another controlling circuit electrically connectable between said power adapter and said another converter, said another converter used for converting said first voltage power from said power adapter into a third voltage power, and said another controlling circuit used to delay activation time of said another converter for outputting said third voltage power out of said another converter differently from said controlling circuit.
